(19) United States
(12) Patent Application Publication
(10) Pub. No.: US 2007/0244262 A1
(43) Pub. Date: Oct. 18, 2007

(54) Graft copolymers and related methods of preparation

(76) Inventors: Mingfu Zhang, Denver, CO (US); Thomas P. Russell, Amherst, MA (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 11/732,934

(22) Filed: Apr. 5, 2007

Related U.S. Application Data
(60) Provisional application No. 60/790,378, filed on Apr. 5, 2006.

(51) Int. Cl. C08F 297/02

(52) U.S. Cl. 525/242

(57) ABSTRACT

Graft copolymers as can comprise a wide range of graft side chains, available using atom transfer radical polymerization techniques.

This application claims priority benefit of application Ser. No. 60/790,378 filed Apr. 5, 2006, the entirety of which is incorporated herein by reference.

### BACKGROUND OF THE INVENTION

Fluoropolymers are known to possess unique properties such as low surface energy, high chemical and thermal stability, and good mechanical properties. Such compounds have been widely used for various applications including thermal insulators, chemically resistant materials, lubricants, filter membranes, electrical insulators, and the like.

However, fluoropolymers are normally highly hydrophobic and solvophobic, and present certain disadvantages, such as poor solubility, wettability, and miscibility. Fluoropolymers are also susceptible to fouling because of the adsorption of oils and proteins. These problems limit their application in fields such as filtration membranes and medical devices. Modification of commercial fluoropolymers has attracted particular interest due to the desired properties of the modified polymers. Indeed, properties such as wettability, amphiphilicity, biocompatibility, solubility, phase compatibility with other polymers, and adhesion to surfaces can be greatly improved by graft copolymerization of co-monomers from the backbone of fluoropolymers. Depending on the nature of the co-monomer, graft copolymers may possess specific properties while retaining desirable properties of the parent fluoropolymers.

Graft copolymerization of co-monomers from commercial polymers has been achieved free radically. Radicals on the parent polymer chains, which serve as initiating sites for graft copolymerization, are typically produced by exposure to ionizing radiation (Journal of Polymer Science, Part A: Polymer Chemistry 2002, 40, 591-600), using a free-radical initiator (Journal of Macromolecular Science, Reviews in Macromolecular Chemistry and Physics 1994, C34, 555-606), or by thermal decomposition of peroxide groups obtained from ozone treatment (Macromolecules 2002, 35, 9653-9656). However, in these free-radical techniques non polymer-bounded radicals are also generated which can initiate the homopolymerization of co-monomer, to provide mixtures of graft copolymers and the homopolymers. In addition, backbone degradation and gel formation can occur as a result of uncontrolled free radical production, resulting in limited grafting density.

Controlled radical polymerization initiated by secondary fluorines on poly(vinylidene fluoride) (PVDF) has been reported recently (WO 02/22712). However, due to the expected low reactivity of secondary fluorine atoms, the initiating efficiency is often very low (e.g., ˜0.1% for the graft copolymerization of tert-butyl methacrylate) (See, Macromolecules 2002, 35, 7652-7661), which results in low grafting density. The distribution of grafts along the PVDF backbone is also difficult to control. Moreover, the graft copolymerization proceeds very slowly, which may result in the homopolymerization of co-monomers by thermal initiation at elevated temperatures. In addition, the low reactivity of secondary fluorine limits the choice of co-monomers.

### SUMMARY OF THE INVENTION

In light of the foregoing, it is an object of the present invention to provide graft fluoro-copolymers and methods for their preparation, thereby overcoming various deficiencies and shortcomings of the prior art, including those outlined above. It will be understood by those skilled in the art that one or more aspects of this invention can meet certain objectives, while one or more other aspects can meet certain other objectives. Each objective may not apply equally, in all its respects, to every aspect of this invention. As such, the following objects can be viewed in the alternative with respect to any one aspect of this invention.

It can be an object of the present invention to provide a method for graft copolymerization of comonomers based on fluoropolymers via a free radical route substantially absent nonpolymeric radicals to minimize unwanted side reactions.

It can be another object of the present invention, alone or in conjunction with the preceding, to provide a polymerization method affording good control over molecular weight and polydispersity.

It can be another object of the present invention, alone or in conjunction with one or more of the preceding objectives, to provide a polymerization method and resulting polymer compounds with predictable grafting density and distribution of grafts.

It can be yet another object of this invention, in light of the preceding, to provide a wide range of graft fluoro-copolymers with substantially less limitation as to choice of grafted polymeric component or corresponding comonomer(s), to afford such copolymers desired chemical and/or physical properties.

Other objects, features, benefits and advantages of the present invention will be apparent from this summary and subsequent descriptions of certain embodiments, and will be readily apparent to those skilled in the art having knowledge of various fluoropolymers, graft copolymers and polymerization techniques. Such objects, features, benefits and advantages will be apparent from the above as taken into conjunction with the accompanying examples, data, figures and all reasonable inferences to be drawn therefrom, alone or with consideration of the references incorporated herein.

In part, this invention can be directed to a method of graft polymerization. Such a method can comprise providing a fluoropolymer compound comprising at lease one chlorotrifluoroethylene (CTFE) unit; providing at least one vinyl compound; and contacting the polymer and vinyl compounds under reaction conditions comprising the presence of an atom transfer radical polymerization (ATRP) catalyst or complex. Such contact and reaction conditions can be at least partially sufficient for graft polymerization of the vinyl compound initiated from the fluoropolymer compound.

Compositionally, the fluoropolymer compound identity is limited only by the presence of at least one CTFE monomeric unit. In certain non-limiting embodiments, such a fluoropolymer compound can comprise copolymers of CTFE with monomers selected from vinyl fluoride, vinylidene fluoride, trifluoroethylene, tetrafluoroethylene, hexfluoropropylene, alkyl vinyl ether, alkyl vinyl ester, ethylene, propylene and combinations thereof.

Likewise, a vinyl compound used in conjunction with such a compound is limited only by reaction with such a fluoropolymer compound, as described herein. In certain non-limiting embodiments, a vinyl compound can be selected from styrene and its derivatives, acrylic acid esters, methacrylic acid esters, acrylonitrile, acrylamides, methacrylamides, and combinations thereof. Sequential use of two or more such vinyl compounds can provide block graft copolymers with corresponding side chains, properties and structure.

In certain embodiments, a fluoropolymer compound can be a copolymer of CTFE and vinylidene fluoride. Regardless, representative of one or more aspects of this invention, an acrylic acid ester can be grafted onto such a fluoropolymer to provide a graft copolymer with the side chains of poly(acrylic acid ester). Such a graft component can be subjected to further chemistry. For instance, hydrolysis of the ester moieties can provide a graft poly(acrylic acid) to enhance hydrophilic character of the resulting graft copolymer. Representative of certain other embodiments, graft polymerization of poly(ethylene oxide) methacrylate can be used to modify or enhance one or more physical or chemical characteristics of the resulting graft polymer for subsequent use in an anti-biofouling application.

In part, this invention can also be directed to a method of using CTFE to initiate atom transfer radical polymerization. Such a method can comprise providing a reaction medium comprising a vinyl compound and a fluoropolymer compound comprising at least one CTFE unit; and contacting the medium with an atom transfer radical polymerization catalyst complex for a time at least partially sufficient for polymerization of the vinyl compound initiated from CTFE units in the fluoropolymer. A fluoropolymer compound employed in such a method can be selected as described above. In certain embodiments, the fluoropolymer compound can be a random copolymer of CTFE and one or more other monomeric components. In certain other embodiments, such a fluoropolymer compound can be a block copolymer comprising CTFE and one or more other monomeric components. Likewise, as described above, a vinyl compound is limited only by graft polymerization under conditions of the sort described herein. Regardless, grafting density and distribution of grafts can be tuned by controlling corresponding density and distribution of CTFE monomeric units within a fluoropolymer compound. Such compounds and compositional variations thereof are available from several commercial sources and can be designed with predetermined CTFE density and distribution (e.g., random, alternating, or block copolymers) using synthetic techniques well known to those skilled in the art, depending upon particular need and/or end-use application. For instance, without limitation, copolymers of alternating CTFE and alkyl vinyl ether monomeric units, with CTFE monomer percentage up to about 50%, can be used to provide corresponding grafting density and distribution, regardless of the polymeric component grafted thereto.

In part, the present invention can also comprise a system for atom transfer radical polymerization. Such a system can comprise a fluoropolymer comprising at least one CTFE monomer unit, a vinyl compound, a catalyst complex comprising a copper(I) salt and a multi-dentate amine or nitrogenous ligand component and, a suitable reaction medium. As would be understood by those skilled in the ATRP art, such a copper(I) compound can comprise a copper(I) halide, which forms a chelation product with a nitrogenous or amine ligand component. In certain non-limiting embodiments, such a ligand can be selected from 2,2′-bipyridine and 2,2′-bipyridines substituted at either one or both of the 4 and 4′-positions with one or more alkyl moieties, and multi-dentate amine ligands such as ethylenediamine, diethylenetriamine, and triethylenetetramine, each of which can comprise at least one N-substituent independently selected from alkyl, cycloalkyl, and aryl substituents. Examples of such substituted bipyridine ligands include 4,4′-di(5-nonyl)-2,2′-bipyridine and various other bipyridyl ligands comprising one or more such alkyl substituents as can function to at least partially enhance the solubility of a copper(I) salt in a reaction medium. Such multi-dentate amine ligands can include tetramethylethylenediamine, tetraethylethylenediamine, ditertbutylethylenediamine, 1,1,4,7,7-pentamethyldiethylenetriamine, 1,1,4,7,7-pentabutyldiethylenetriamine, and 1,1,4,7,10,10-hexamethyltriethylenetetramine. Other ligand components and/or substituted derivatives thereof are as would be understood by those in the art made aware of this invention. Likewise, a reaction medium can be selected from one or more solvents corresponding to or the introduction of any one or more reaction components or reagents, such a solvent limited only by facilitation of desired graft polymerization.

Accordingly, this invention can also comprise a range of copolymer compounds comprising a CTFE monomer graft of a formula 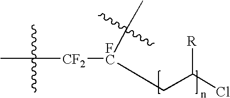
wherein R can be a moiety selected from phenyl, alkylphenyl, alkylcarbonyl, alkoxycarbonyl, amide, nitrile, and oligomeric moieties; and n can be an integer selected from 1 and integers greater than 1. More generally, R can be a moiety of a corresponding vinyl compound corresponding to a polymeric component grafted to a CTFE monomeric unit of fluoropolymer. Accordingly, this invention contemplates a range of graft copolymer compounds where R is limited only by polymerization of a corresponding vinyl compound, as described herein.

In part, the present invention can also be directed to a wide range of polymer compounds, such compounds of a formula 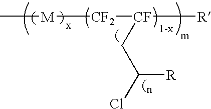
wherein M can be selected from an ethylene unit and an ethylene unit comprising a moiety selected from chloro, fluoro, alkyl, substituted alkyl, alkoxy, alkoxycarbonyl and combinations thereof; R can be selected from H, alkyl, substituted alkyl, aryl, substituted aryl, alkylaryl, substituted alkylaryl, alkylcarbonyl, alkoxycarbonyl, carboxy, amide, nitrile, and poly(alkylene oxide) moieties; m can be an integer selected from 1 and integers greater than 1; n can be an integer selected from 1 and integers greater than 1; x can range from 0 to less than about 1; and R′ can be a polymerization termination moiety of the sort known in the art and/or as would be incorporated into such a compound, to terminate polymerization, under reaction conditions of the sort described herein. Alternatively, such compounds can be expressed, as would be understood by those in the art, without specific reference to any such termination moiety.

In certain embodiments, M can be a unit selected from vinyl fluoride, vinylidene fluoride, trifluoroethylene, tetrafluoroethylene, hexafluoropropylene, alkyl vinyl ether, alkyl vinyl ester, ethylene, propylene, and combinations thereof. Accordingly, such a compound can be selected from the full range of available random, alternating, and block copolymers comprising any one or more such M units. Regardless, R can be selected from aryl, substituted aryl, alkylaryl, alkylcarbonyl, alkoxycarbonyl, carboxy, amide, nitrile, and poly(alkylene oxide) moieties. Without limitation as to either M or R identity, such a polymer compound can be obtainable from a graft polymerization method of the sort described herein, with an atom transfer radical polymerization catalyst comprising a copper(I) salt and a nitrogenous or amine ligand, each as also described herein or as would be known to those skilled in the art made aware of this invention.

Regardless of M or R or graft identity, a resulting graft copolymer can be used as would be understood as a compatibilizer in a composition comprising the parent fluoropolymer and other polymers or compounds otherwise at least partially immiscible with the fluoropolymer but for incorporation of the grafted polymeric component. For instance, under certain conditions, a polystyrene can be immiscible with a fluoropolymer comprising CTFE. Graft polymerization, as described herein, can provide a grafted copolymer (e.g., R is phenyl) to suitably blend polystyrene with the fluoropolymer.

Alternatively, such a graft copolymer can be incorporated with other materials or used to prepare articles having properties corresponding thereto. For instance, without limitation, any such graft copolymer can be deposited on or coupled to a substrate material to provide a corresponding composite, for subsequent use in a range of device structures. Non-limiting embodiments include use of graft copolymers having biocompatible and/or anti-biofouling characteristics in the fabrication of medical devices. Alternatively, in various other non-limiting embodiments, such graft copolymers having physical or chemical characteristics imparted by the grafted polymeric component (e.g., amphiphilic, pH-sensitive, temperature-sensitive, etc.) can be used in the preparation of a range of functional filtration membranes providing such properties.

With respect to the polymer or copolymer compounds, compositions, articles/devices and/or methods of the present invention, the monomeric components or units thereof can suitably comprise, consist of, or consist essentially of any of the aforementioned moieties or substituents thereof. Each such polymer or copolymer compound, monmeric unit and/or moiety/substitutent thereof is compositionally distinguishable, characteristically contrasted and can be practiced in conjunction with the present invention separate and apart from another. Accordingly, it should also be understood that the inventive compounds, compositions, articles/devices and/or methods, as illustratively disclosed herein, can be practiced or utilized in the absence of any one monomeric unit, moiety, substituents and/or step which may or may not be disclosed, referenced or inferred herein, the absence of which may or may not be specifically disclosed, referenced or inferred herein.

### DETAILED DESCRIPTION OF THE DRAWINGS

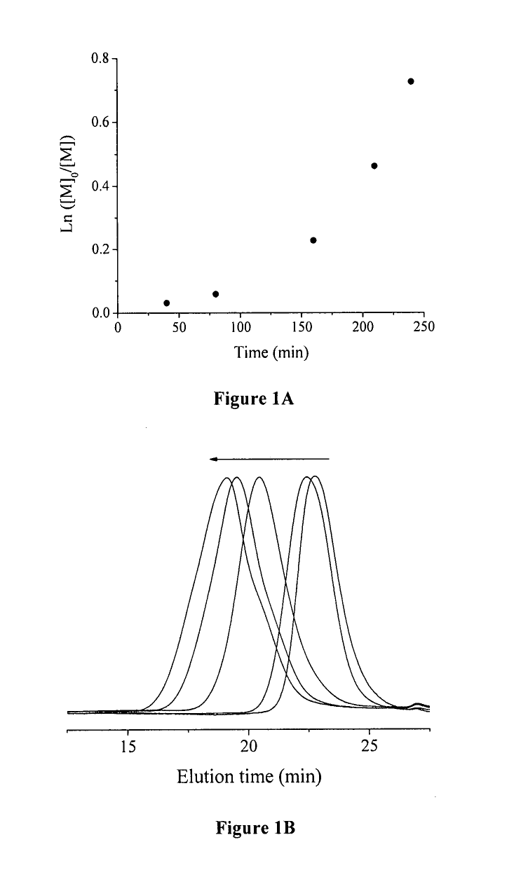

FIGS. 1A-B. Heterogeneous ATRP of styrene initiated by PCTFE oligomer at 120° C. (Run 1, Table 1); 0.8[Cl]o=[CuCI]o=[PMDETA]o=0.01[styrene]o=0.08 M; (A) Semilogarithmic kinetics plot (where [M]o and [M] represent the monomer concentration at the reaction time of 0 and t respectively); (B) SEC traces of the resultant polymers at different polymerization times (from right to left: 40 min, 80 min, 160 min, 210 min, and 240 min).

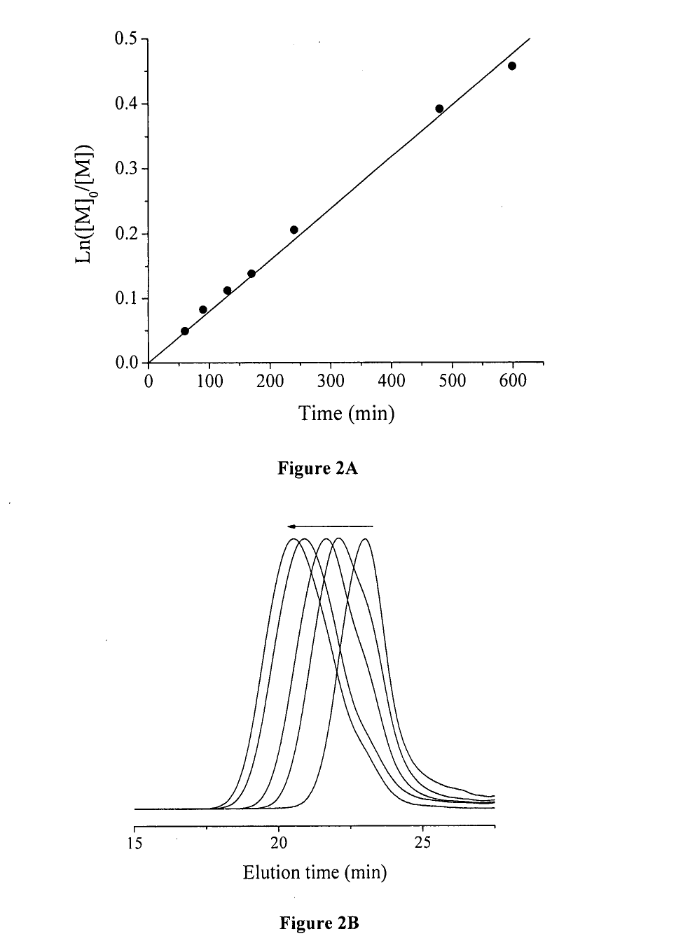

FIGS. 2A-C Homogeneous ATRP of styrene initiated by PCTFE oligomer at 120° C. (Run 3, Table 1); 0.8[Cl]o=2[CuCI]o=[BPy]o=0.01[styrene]o=0.0465M; (A) Semilogarithmic kinetics plot; (B) SEC traces of the resultant polymers at different polymerization times (from right to left: 60 min, 170 min, 240 min, 480 min, and 600 min); (C) The dependence of apparent number average molecular weight (Mn) upon monomer conversion.

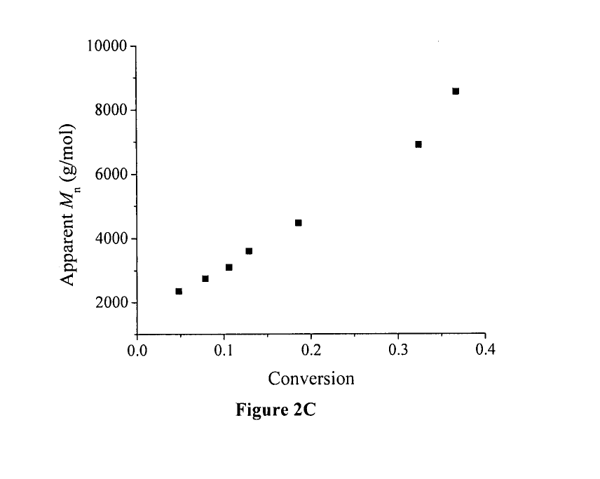

FIGS. 3A-B. Graft copolymerization of styrene from P(VDF-co-CTFE)-31508 at 120° C. in NMP (Run 4 in Table 2). (A) Semilogarithmic kinetics plot; (B) SEC traces of the resultant graft copolymer at the polymerization time of 12 h (solid line) and of the corresponding fluoropolymer, P(VDF-co-CTFE)-31508 (dash line).

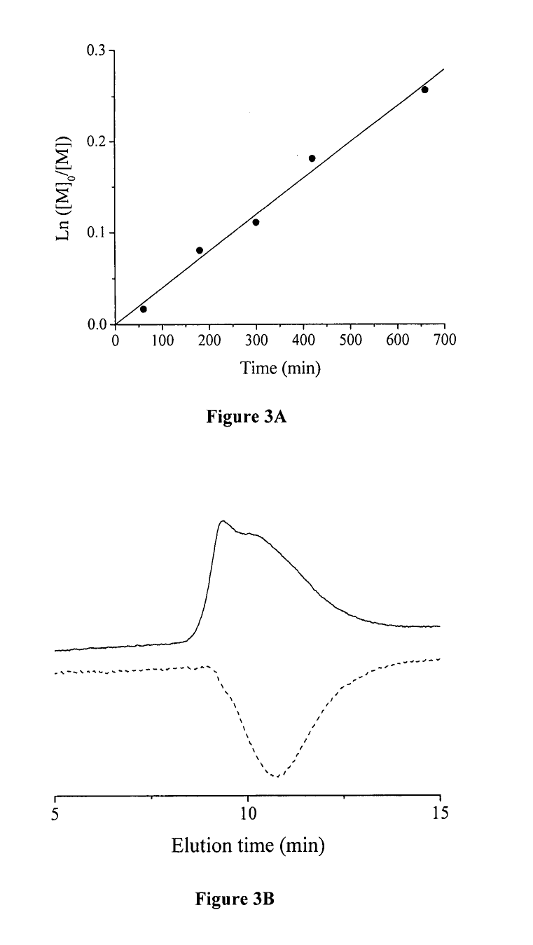

FIG. 4. The ¹H-NMR spectra of (a) P(VDF-co-CTFE)-31008 and (b) P(VDF-co-CTFE)-g-PS (Run 2, Table 2) in DMF-d7. Resonances located at 2.75, 2.92, and 3.51 ppm are the solvent peaks.

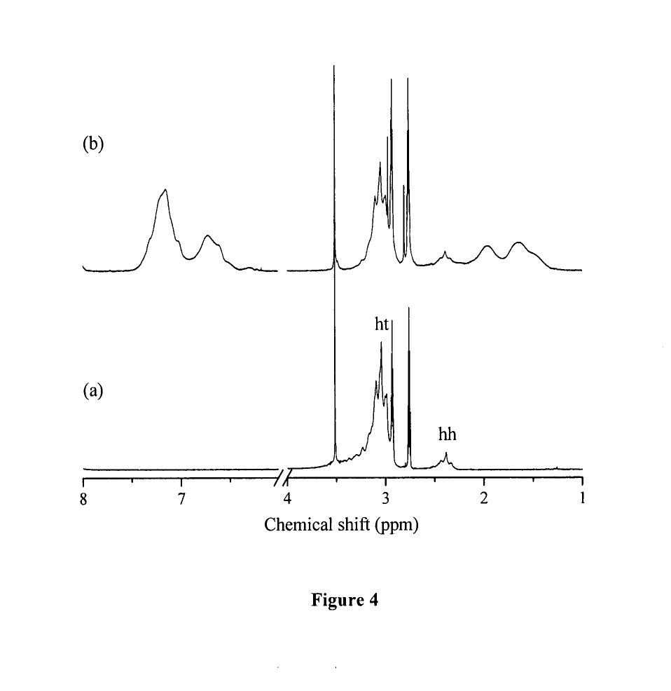

FIGS. 5A-B. DSC thermograms upon heating at 10° C./min for (a) P(VDF-co-CTFE)-31008; (b) P(VDF-co-CTFE)-g-PS (Run 2, Table 3).

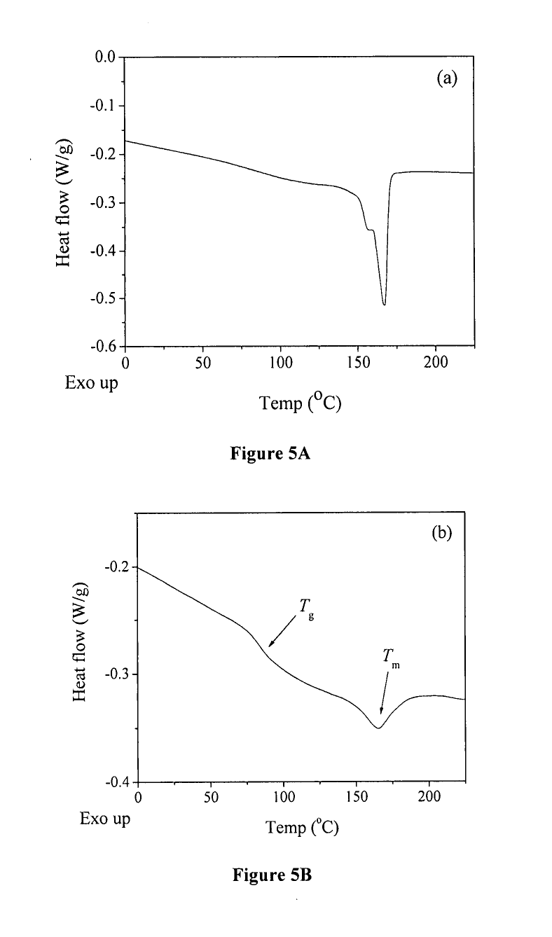

FIGS. 6A-B. Digital AFM height images (3 pm×3 pm) of (A) P(VDF-co-CTFE)-31008 and (B) P(VDF-co-CTFE)-g-PS (Run 2, Table 3) thin films on silicon wafer.

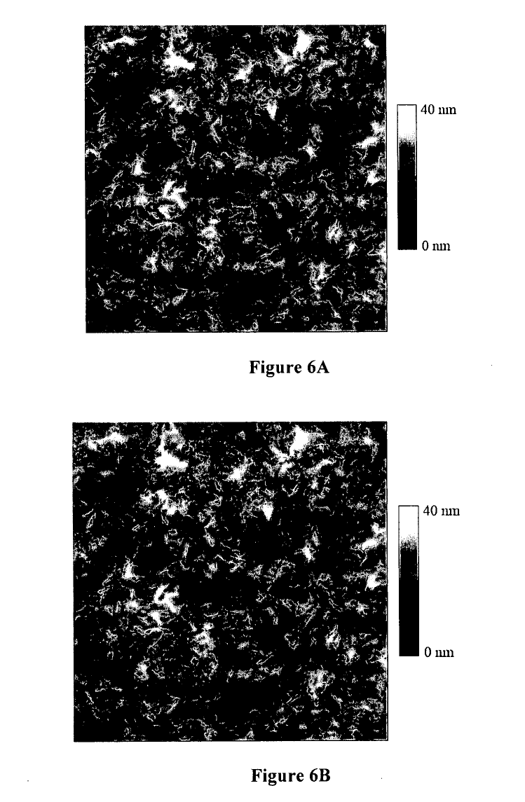

FIG. 7. GPC traces of P(VDF-co-CTFE)-31508 (dash line) and the grafted copolymer (solid line) resulted from the polymerization of tBA at 70° C. in NMP for 1 h; [Cl]/[CuCl]/[PMDETA]/[tBA]=1/0.8/0.8/41; V_{S}/V_{M}=1.1/1 (Run 4, Table 3).

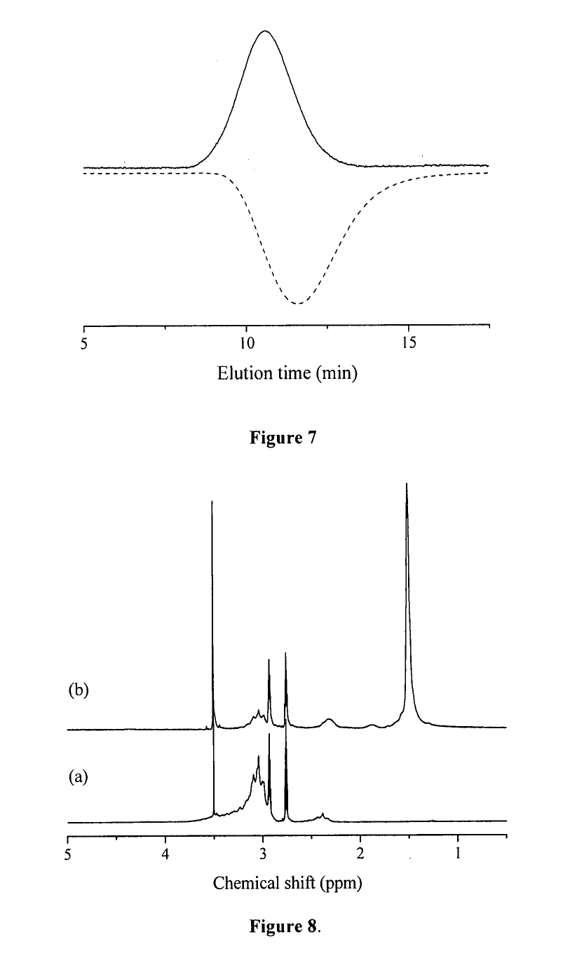

FIG. 8. The ¹H-NMR spectra of (a) P(VDF-co-CTFE)-31508 and (b) P(VDF-co-CTFE)-g-PtBA (Run 2, Table 4) in DMF-d7.

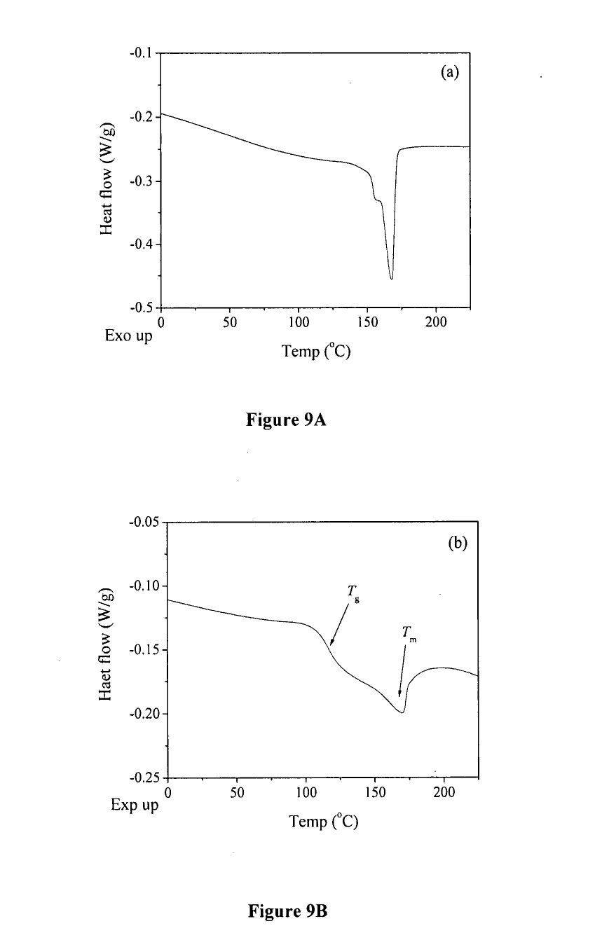

FIGS. 9A-B. DSC thermograms upon heating at 10° C./min for (A) P(VDF-co-CTFE)-31508; (B) P(VDF-co-CTFE)-g-PtBA (Run 3, Table 4).

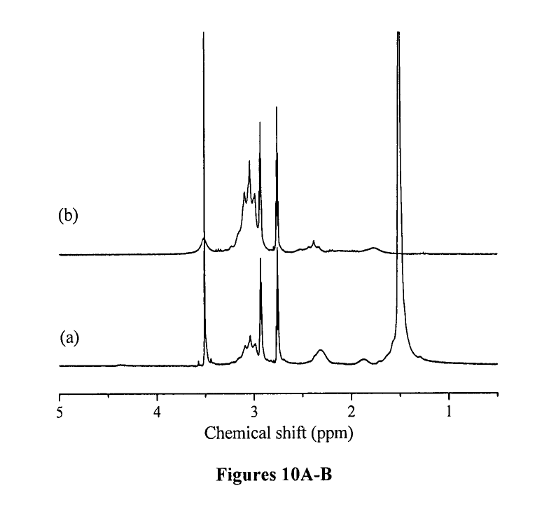

FIGS. 10A-B. The ¹H-NMR spectra of P(VDF-co-CTFE)-g-PtBA (Run 2, Table 3) (A) and its hydrolysis product P(VDF-co-CTFE)-g-PAA (B) in DMF-d7.

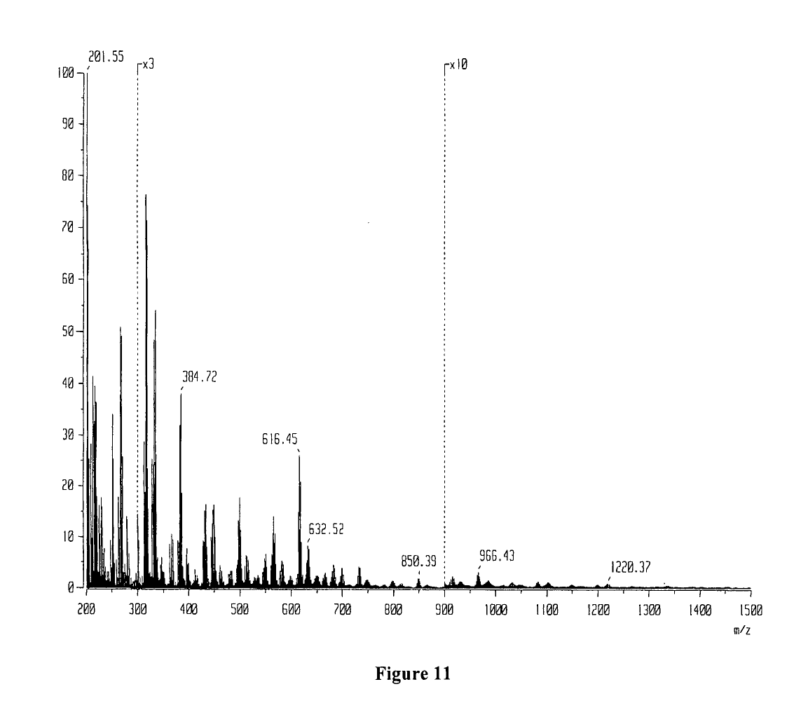

FIG. 11. Mass spectrum of PCTFE oligomer (Ion mode: FAB+; Spectrum type: normal ion (MF-linear)); Note that the intensity between 300-900 m/z was magnified by a factor of 3 and the intensity above 900 m/z was magnified by a factor of 10.

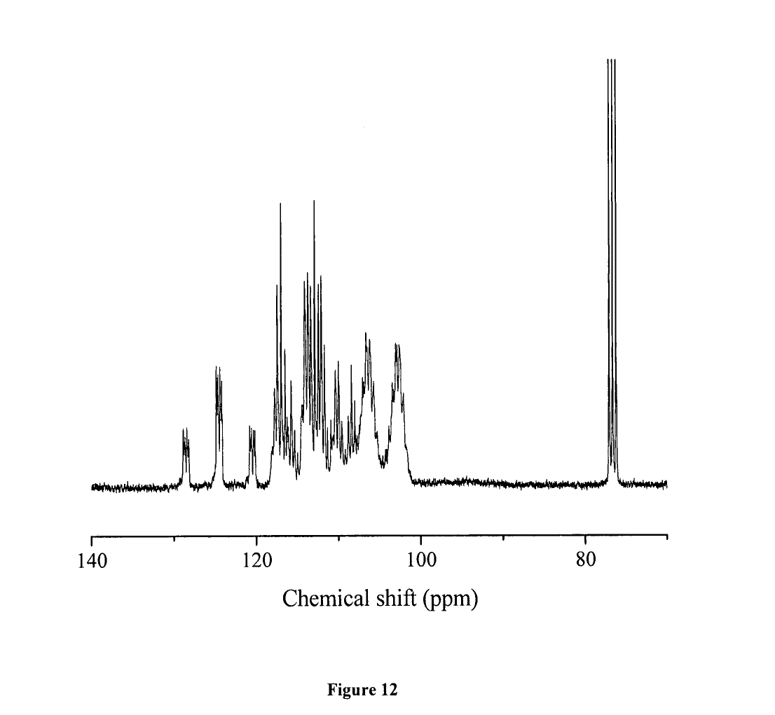

FIG. 12. ¹³C-NMR spectrum of the PCTFE oligomer in CDCl₃ (The triple peak located at ˜77 ppm corresponds to the solvent (CDCl₃) peak).

### DETAILED DESCRIPTIONS OF CERTAIN EMBODIMENTS

The present invention provides a convenient approach to graft various polymer chains from the backbone of fluoropolymers comprising chlorotrifluoroethylene (CTFE) unit(s)—as can be accomplished in a single-step synthetic process. The graft copolymerization is carried out in solution via atom transfer radical polymerization (ATRP). The secondary chlorine atom in CTFE serves as an initiating site. A catalyst comprising a transition metal halide (such as Cu(I) halide) coordinated to ligands (such as bipyridine) can be used to generate radicals on fluoropolymers via atom transfer. The invention enables the fabrication of materials comprising grafting copolymers, in which different polymeric side chains are grafted from the backbone of fluoropolymers. Depending on the co-monomer used for graft copolymerization, both hydrophobic (such as polystyrene) and hydrophilic (such as poly(acrylic acid)) side chains can be grafted. The graft copolymers may be used as novel membrane materials, compatilizers between fluoropolymers and non-fluoropolymers, and the like.

Without limitation to any one theory or mode of operation, the unusual high reactivity of the secondary chlorine atom in CTFE is believed to initiate atom transfer radical polymerization. Different from the chlorine atom in commercial chlorinated polyolefins such as poly(vinyl chloride) (PVC), which was found in the literature to be too strongly bonded to initiate the polymerization by reaction with Cu(I) complex, the secondary chlorine in CTFE is much more reactive with respect to radical generation. As a model reaction, low molecular weight poly(chlorotrifluoroethylene) (PCTFE) oligomers (molecular weight=400˜500) were used as initiators for ATRP. For example, in the polymerization of styrene using PCTFE oligomer as initiator, the radical concentration is constant during the polymerization as evidenced by the first-order polymerization kinetics, and the molecular weight of the resulted polymer increases with monomer conversion while the molecular weight distribution keeps narrow. All these characteristics are typical for ATRP. The high reactivity of the chlorine atoms in CTFE indicates the ability of the fluorine atoms to activate the chlorine atom toward atom transfer.

Graft copolymers can be prepared from commercial fluoropolymers containing CTFE units via ATRP. For example, graft copolymerizations of various co-monomers (e.g., styrenes, and acrylates) from copolymers of vinylidene fluoride (VDF) and CTFE (poly(VDF-co-CTFE)) via ATRP were carried out and the reactions proceeded in a living and controlled manner, indicated by the study of polymerization kinetics. The monomodal molecular weight distribution of the resultant graft copolymer indicates the absence of homopolymerization and coupling reactions. In addition, the polymerization proceeded much faster than the similar graft copolymerization initiated by secondary fluorines in PVDF, as reported by in the literature.

Control experiments using poly(vinylidene fluoride) (PVDF) as a macroinitiator under the same polymerization conditions show that no appreciable grafting occurs, indicating the large difference in reactivity between chlorine and fluorine atoms toward atom transfer. On these results, graft copolymerization based on poly(VDF-co-CTFE) is believed to be initiated exclusively by the chlorine atoms in CTFE units, while the fluorine atoms remain intact under the polymerization conditions applied. Common ATRP catalyst system (for example, CuCl/bipyridine or CuCl/1,1,4,7,7-pentamethyldiethylenetriamine (PMDETA)) is sufficient to catalyze the reaction.

Because of its radical nature, ATRP provides numerous advantages over ionic polymerizations: suitable to a large variety of monomers, tolerant to functional groups and impurities, and mild reaction conditions. The present invention enables ATRP and its associated advantages to be more effectively utilized. Because of the high reactivity of chlorine atom in CTFE toward atom transfer, a wide range of vinyl monomers (e.g., styrenes, acrylates, and methacrylates, etc.) can be polymerized and various polymer chains can be grafted from the backbone of fluorinated polymers, which offers a broad choice of co-monomers for various specific applications. Compared to other free-radical techniques, the overall concentration of radicals in ATRP is very low and remains constant throughout the polymerization, which minimizes the termination, cross-linking, and chain transfer reactions. Graft copolymerization via ATRP as employed in conjunction with this invention, offers good control of molecular weight and polydispersity. Moreover, chemical reagents are commercially available and can be used directly, and cost-effectively, without further purification.

Various fluorocopolymers containing CTFE units have been and are commercially available, such as poly(vinylidene fluoride-co-chlorotrifluoroethylene) (Solvay Solef® VF₂-CTFE), poly(ethylene-co-chlorotrifluoroethylene) (Solvay Halar® ECTFE, Vatar® ECTFE), copolymers of chlorotrifluoroethylene with alkyl vinyl ether or alkyl vinyl ester (Asahi Glass Lumiflon®), poly(chlorotrifluoroethylene-co-vinylidene fluoride-co-tetrafluoroethylene), and etc. Such compounds have been widely used in the manufacture of many products due to their high mechanical strength and excellent thermal and chemical stability. Although poly(chlorotrifluoroethylene) (PCTFE) is insoluble in almost all organic solvents at room temperature, copolymers containing chlorotrifluoroethylene units (such as poly(VDF-co-CTFE)) can be dissolved in polar organic solvents, which makes the radical graft copolymerization in solution possible—demonstrating another unique characteristic of the present invention.

Illustrating various aspects of this invention, consider the graft copolymerization of styrene and tert-butyl acrylate (tBA) from poly(vinylidene fluoride-co-chlorotrifluoroethylene) (P(VDF-co-CTFE)) via ATRP. Model reactions using poly(chlorotrifluoroethylene) (PCTFE) oligomer as ATRP initiator showed that the secondary chlorines in PCTFE were much more reactive than those in PVC with respective to radical generation under ATRP conditions, indicating the ability of fluorine atoms to activate the chlorines toward atom transfer.

By hydrolyzing poly(tert-butyl acrylate) (PtBA) side chains of the graft copolymers, P(VDF-co-CTFE)-g-PtBA, amphiphilic graft copolymers with poly(acrylic acid) (PAA) side chains were prepared. These amphiphilic fluoropolymers have potential applications as in the preparation of filtration membranes with engineered surface properties.

Model Reactions Using PCTFE Oligomer as ATRP Initiator

To determine the reactivity of secondary chlorines in poly(chlorotrifluoroethylene) (PCTFE) with respective of radical generation, copper-mediated atom transfer radical polymerizations (ATRP) of styrene were carried out using PCTFE oligomer as initiator (Scheme 1). High molecular weight PCTFE could not be used because it is insoluble in most of organic solvents. Commercially available ligands, such as 2,2′-bipyridine (BPy) and 1,1,4,7,7-pentamethyldiethylenetriamine (PMDETA), were used in the model reactions.

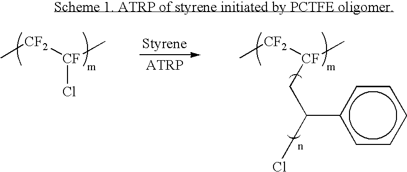

Polymerization of styrene initiated by the PCTFE oligomer proceeded very rapidly when CuCl/PMDETA was used as the ATRP catalyst system with the molar ratio of Cl/CuCl/PMDTEA of 1/0.8/0.8 (Runs 1-2, Table 1). Since the CuCl/PMDTEA (and also CuCl/BPy) complex is insoluble in styrene, polar solvents, like N-methyl-pyrrolidinone (NMP), were added in order to obtain a homogeneous polymerization system. When the amount of polar solvent was not enough, like in Run 1 in Table 1, CuCl/PMDETA complex was not completely dissolved and thus the reaction system was heterogeneous. Size exclusion chromatography (SEC) measurements showed that the molecular weight of polymer increased with increasing monomer conversion. However, the polymerization rate was not first-order with respect to the monomer concentration, as shown in FIG. 1a. Obviously the concentration of radicals increased with polymerization time. The acceleration of polymerization is most likely due to the slow initiation, because of the low solubility of CuCl/PMDETA complex in the reaction mixture. When more polar solvent (NMP) was added, such that the reaction mixture was homogeneous (Run 2, Table 1), the polymerization exhibited perfect first-order kinetics with respect to the monomer concentration, which is characteristic for ATRP. However, the SEC traces of the resultant polymers show bimodal molecular weight distribution even at the initial stage of polymerization, indicating the occurrence of radical coupling, more than likely due to the high concentration of reactive radicals.

TABLE 1
Homopolymerization of styrene (St) and sequential block copolymerization of styrene
and tert-butyl acrylate (IBA) initiated by PCTFE oligomer

| Run | Initiator/ | Catalyst/ | [Cl]/[CuCl]/ | Solvent | Temp. | Time | Conv. | Mₙ | |
|---|---|---|---|---|---|---|---|---|---|
| No. | Monomer | Ligand | [Lig]/[M]^{a} | (V_{S}/V_{M})^{b} | (° C.) | (h) | (%) | (×10³)^{c} | PDI^{c} |
| Run 1 | PCTFE/St | CuCl/ | 1/0.8/ | NMP | 120 | 4 | 51.6 | 22.1 | 1.79 |
| | | PMDETA | 0.8/80 | (1/11.5) | | | | | |
| Run 2 | PCTFE/St | CuCl/ | 1/0.8/ | NMP | 120 | 2.5 | 53.9 | 17.6 | 2.25^{d} |
| | | PMDETA | 0.8/80 | (1/1.15) | | | | | |
| Run 3 | PCTFE/St | CuCl/ | 1/0.4/ | NMP | 120 | 10 | 36.7 | 8.56 | 1.60 |
| | | BPy | 0.8/80 | (1/1.15) | | | | | |
| Run 4 | Polymer | CuCl/ | 1^{e}/0.8/ | NMP | 70 | 0.5 | 56.3 | 12.9 | 2.03 |
| | from Run 3/ | PMDETA | 0.8/160 | (1/1.15) | | | | | |
| | tBA | | | | | | | | |

^{a}[Cl]/[CuCI]/[Lig]/[M] is the initial molar ratio of chlorine, CuCl, ligand, and monomer;
^{b}V_{S}/V_{M} is the volume ratio between solvent and monomer;
^{c}obtained from SEC in THE using polystyrenes as calibration standards;
^{d}bimodal molecular weight distribution;
^{e}calculated based on the monomer conversion in Run 3.

By using BPy as the ligand and decreasing the concentration of catalyst (Run 3, Table 1), polymers with controlled molecular weights and relatively narrow molecular weight distribution were obtained. Although the polymerization was much slower in this case, first-order polymerization kinetics was observed, as shown in FIG. 2a. The resultant polymer has a polydispersity index of 1.60, which is higher than that of linear polymers synthesized from typical ATRP. However, taking into account that the initiator used is a mixture of multifunctional PCTFE oligomers with different degrees of polymerization, as indicated by the mass spectroscopy measurement (see the supporting information), the somehow broader molecular weight distribution of the resultant polymer is to be expected. The reason for the appearance of a faint shoulder at the low molecular weight side of the SEC traces shown in FIG. 2b is unclear yet, but it may stem from the distribution of PCTFE oligomer. The increase in molecular weight with monomer conversion (FIG. 2c), in conjunction with the first-order polymerization kinetics, indicates that this polymerization process was living.

To further confirm that the polymerization discussed above was a living process, the resultant polystyrene was further used as macroinitiator to polymerize tert-butyl acrylate (tBA). Indeed, the ATRP of tBA initiated by the polystyrene synthesized in Run 3 in Table 1 proceeded very rapidly. The increase in the molecular weight (Run 4, Table 1) indicates the successful block copolymerization, strongly supporting the living nature of ATRP initiated by PCTFE oligomer.

Based on the model reactions described above, it is clear that PCTFE oligomer was able to initiate homopolymerization of styrene and block copolymerization of styrene and tBA under ATRP conditions. Since PCTFE oligomer contains secondary chlorines and secondary fluorines, which both are potential ATRP initiators, it is necessary to distinguish whether the polymerizations were initiated by secondary chlorines exclusively or by both of them. Thus, the control experiment using poly(vinylidene fluoride) (PVDF) as the macroinitiator was carried out, and the results showed that PVDF couldn't initiate ATRP of styrene under the polymerization conditions we used. Combining the results from both the model reactions and the control experiment, it is clear that the initiating site in PCTFE oligomer was the secondary chlorine. Compared with the secondary chlorines in poly(vinyl chloride) (PVC), which were found to be too strongly bonded to initiate ATRP, the high reactivity of secondary chlorines in PCTFE indicates the ability of fluorine atoms to activate the chlorines toward atom transfer.

Graft Copolymerization of Styrene from P(VDF-co-CTFE)

The ability of secondary chlorine in PCTFE oligomer to initiate ATRP can be used to prepare graft copolymers from commercial fluoropolymers containing CTFE units. In this work, commercial available copolymers of vinylidene fluoride and chlorotrifluoroethylene, P(VDF-co-CTFE), were used as macroinitiators to prepare graft copolymers via ATRP (Scheme 2). Two P(VDF-co-CTFE) copolymers, that contain 12.0 w % and 18.7 w % of CTFE respectively (as shown in Table 2), were used as macroinitiators. They have a pseudo-block structure, with a long VDF-rich block and a short CTFE-rich block. Thus, the initiating sites are densely distributed in the CTFE-rich block.

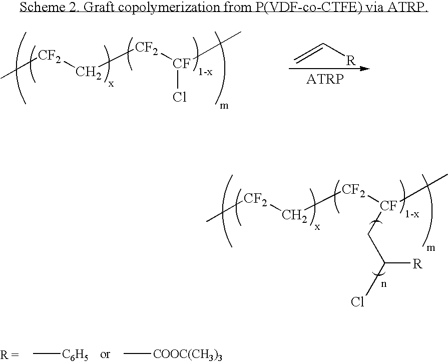

In the graft copolymerization from a macroinitiator with multiple initiating sites, cross-linking is often caused by radical coupling. In ATRP the reversible deactivation of radicals to dormant species lowers the overall radical concentration significantly and, thus, minimizes irreversible terminations (like radical coupling), but the high local concentration of initiating sites along the macroinitiator still increases the possibility of cross-linking dramatically. So the experimental conditions for graft copolymerization should be optimized such that cross-linking is reduced as much as possible. It has been reported that by adding a radical deactivator (Cu(II)), terminating the polymerization at relatively low monomer conversion, and/or using solvents, the cross-linking during graft copolymerization can be suppressed significantly and thus well-defined graft copolymers can be prepared.

Since the macroinitiator, P(VDF-co-CTFE), is insoluble in monomers such as styrene and tert-butyl acrylate, polar solvents (such as DMF and NMP) were used to dissolve the macroinitiator. The addition of polar solvents also helped to dissolve the Cu(I) complex, ensuring a homogeneous reaction system.

TABLE 2
Graft copolymerization of styrene (St) from P(VDF-co-CTFE)s

| Run | | Catalyst/ | [Cl]/[CuCl]/ | Solvent | Temp. | Time | Conv. | Mₙ | | W_{PS} |
|---|---|---|---|---|---|---|---|---|---|---|
| No. | Initiator | Ligand | [Lig]/[St]^{b} | (V_{S}/V_{M})^{c} | (° C.) | (h) | (%) | (×10⁵)^{d} | PDI^{d} | (%)^{e} |
| Run 1 | P(VDF-co- | CuCl/ | 1/0.9/ | DMF | 90 | — | Gel | — | — | — |
| | CTFE)- | PMDETA | 0.8/42 | (3/1) | | | | | | |
| | 31008^{a} | | | | | | | | | |
| Run 2 | P(VDF-co- | CuCl/ | 1/0.8/ | NMP | 120 | 24 | 33.7 | 2.94 | 1.75 | 57.0 |
| | CTFE)- | BPy | 1.7/43 | (3.9/1) | | | | | | (60.8) |
| | 31008 | | | | | | | | | |
| Run 3^{f} | PVDF | CuCl/ | 0/0.8/ | NMP | 120 | 24 | 34.7 | — | — | — |
| | | BPy | 1.7/43 | (3.9/1) | | | | | | |
| Run 4 | P(VDF-co- | CuCl/ | 1/0.4/ | NMP | 120 | 12 | 25.0^{g} | 3.28 | 1.59 | 52.2 |
| | CTFE)- | BPy | 0.4/40 | (2/1) | | | | | | (62.6) |
| | 31508^{a} | | | | | | | | | |

^{a}P(VDF-co-CTFE)-31008: number-average molecular weight (Mₙ) = 1.77 × 10⁵ g/mol, polydispersity index (PDI) = 1.52; P(VDF-co-CTFE)-31508: Mₙ = 1.80 × 10⁵ g/mol, PDI = 1.47;
^{b}[Cl]/[CuCI]/[Lig]/[St] is the initial molar ratio of chlorine, CuCI, ligand, and styrene;
^{c}V_{S}/V_{M} is the volume ratio between solvent and monomer (styrene);
^{d}obtained from SEC in DMF using polystyrenes as calibration standards;
^{e}weight percentage of polystyrene in the resultant graft copolymers determined by elemental analysis (the data in the parentheses represent the calculated values based on the monomer conversion);
^{f}control experiment;
^{g}estimated based on the first-order polymerization kinetics as shown in FIG. 3a.

Similar to the model reactions, when CuCl/PMDETA was used as catalyst for the graft copolymerization of styrene from P(VDF-co-CTFE) in solution, the reaction proceeded very rapidly. Actually, gelation (cross-linking) occurred instantly once the reaction flask was immersed in oil bath (Run 1, Table 2). This is a clear indication of the high radical concentration and thus the high reactivity of the secondary chlorine in CTFE with respect to the radical generation under the polymerization conditions used.

When CuCl/BPy was used as catalyst, the graft copolymerization in solution was found to be a living process, indicated by the first-order polymerization kinetics (FIG. 3a). SEC measurements showed that the initial negative refractive index signal (relative to solvent) of the macroinitiator changed to a positive one and the molecular weight increased after the graft copolymerization, as shown in FIG. 3b. In addition, the graft copolymers have strong UV absorption at 254 nm, while P(VDF-co-CTFE) has no absorption at this wavelength. The molecular weight distribution (MWD) of the resultant graft copolymer is bimodal, although its polydispersity is just slightly higher than that of the macroinitiator. To ensure the bimodality was not due to the existence of polystyrene homopolymer, which may form via thermal initiation, the resultant copolymer was washed with cyclohexane. The SEC trace was virtually unchanged after washing. Instead, this bimodal distribution was likely a result of radical-radical coupling of chains during polymerization, which has been observed previously in ATRP graft copolymerizations. Since the overall radical concentration was nearly constant (as indicated by the first-order polymerization kinetics) and the resultant graft copolymer was still soluble, so the extent of radical coupling must be negligible.

Because P(VDF-co-CTFE) is insoluble in deuterated chloroform (CDCl₃, which is used as solvent for proton nuclear magnetic resonance (¹H-NMR) measurements for polymerization kinetics study), precipitation occurred when the initial kinetic sample was diluted with CDCl₃. During the graft copolymerization, the solubility of kinetic samples in CDCl₃ increased gradually, and eventually a clear solution could be obtained at relatively high monomer conversion. Provided that the content of grafted PS is high enough, the resultant graft copolymers can be dissolved in some solvents, that are bad solvents for P(VDF-co-CTFE). For example, the graft copolymer from Run 2 in Table 2 is soluble in THF, while P(VDF-co-CTFE) is insoluble in THF. This clearly indicates that the grafting of polystyrene improves the solubility of the parent fluoropolymer significantly.

Since the secondary fluorine is also a potential ATRP initiator, a control experiment was carried out to determine whether the secondary fluorine took part in the ATRP initiation during the graft copolymerization of styrene from P(VDF-co-CTFE). PVDF homopolymer (with the molecular weight of ˜100 kg/mol) was used as macroinitiator for the control experiment under exactly the same reaction conditions as those used for Run 2 in Table 2. The monomer conversion was quite similar in both cases. However, after washing the resultant polymer from the control experiment with THF, the SEC measurement showed that the residual polymer had exactly the same SEC trace as that of the starting PVDF, indicating that there was no appreciable initiation from the secondary fluorine for the ATRP of styrene in the control experiment. Instead, polystyrene homopolymer formed in Run 3 (Table 2) due to the thermal initiation. The result of the control experiment indicates that the initiating efficiency of the secondary fluorine in PVDF is not high enough to polymerize styrene via ATRP under the reaction conditions we applied, although PVDF has been successfully used as macroinitiator to initiate the ATRP of methacrylates. Based on the result from the control experiment, we can conclude that the graft copolymerizations from P(VDF-co-CTFE) were initiated from the secondary chlorines in the CTFE units exclusively.

The ¹H-NMR spectra for P(VDF-co-CTFE) and P(VDF-co-CTFE)-g-PS are shown in FIG. 4. The spectrum of P(VDF-co-CTFE) exhibits two peaks at 3.1 ppm and 2.4 ppm, due to the well-known head-to-tail (ht) and head-to-head (hh) bonding arrangements of vinlyidene fluoride units respectively. After the graft copolymerization of styrene, new peaks corresponding to polystyrene grafts appeared at 6.5-7.5 ppm (phenylic protons) and 1.3-2.2 ppm (methylene/methine protons), indicating the successful grafting of PS side chains.

Elemental analysis was used to determine the content of polystyrene side chains in the resultant graft copolymers. As shown in Table 2, both two graft copolymers contain more than 50 w % of polystyrene, this is why they have much higher solubility than the parent fluoropolymer. The content of polystyrene in the graft copolymer determined by elemental analysis is in fairly good agreement with the calculated value based on the monomer conversion.

The resultant graft copolymers consist of a crystalline backbone and amorphous side chains. Thus, differential scanning calorimetry (DSC) was used to investigate their thermal properties and phase separation. FIG. 5 shows DSC thermograms of P(VDF-co-CTFE)-31008 and the corresponding graft copolymer. The DSC thermogram of P(VDF-co-CTFE)-31008 shows a main melting peak at 167° C. with a shoulder at around 158° C. The bimodal melting peak of P(VDF-co-CTFE) may be related to the presence of CTFE units in the copolymer, because pure PVDF showed a single melting peak at 163° C. under the same measurement conditions. After the grafting of PS side chains, in addition to the melting peak (Tₘ=165° C.), a new transition temperature at 84° C. was observed, which should correspond to the glass transition of the PS graft. The existence of both the T_{g} of the PS graft and the Tₘ of the backbone indicates a microphase-separated morphology in this graft copolymer. Two characteristics were observed from the melting peak of the graft copolymer. First, a monomodal melting peak was observed, most probably due to the pseudo-block structure of the P(VDF-co-CTFE) and the selective grafting from the CTFE-rich block. The VDF-rich block of P(VDF-co-CTFE) remained almost intact after the graft copolymerization and, thus, the melting point of the resultant graft copolymer was very similar to the Tₘ of pure PVDF. Secondly, there was almost no melting point depression after graft copolymerization. In contrast, graft copolymers based on PVDF showed a melting point depression relative to the parent PVDF. This again indicates that the grafting occurred solely from the secondary chlorines in the CTFE units, and the VDF units of the macroinitiator remained intact.

Atomic force microscopy (AFM) was used to characterize the thin film morphology of the macroinitiators and resultant graft copolymers. As shown in FIG. 6a, crystalline domains can be easily seen in the AFM image of P(VDF-co-CTFE), and the surface of film is relatively rough. Compared to the parent P(VDF-co-CTFE), thin film of the graft copolymer has a much smoother surface, due to the dramatic decrease in crystallinity upon grafting (as revealed from the DSC measurements). The AFM image of the graft copolymer (FIG. 6b) provides further evidence of the successful graft copolymerization, because macroscopic phase separation would have been observed, if the resultant polymer is a mixture of P(VDF-co-CTFE) and PS homopolymer, due to the known incompatibility between PVDF and PS. These graft copolymers could be of interest for modifying the compatibility between PVDF and PS by blending.

Graft Copolymerization of Tert-butyl Acrylate from P(VDF-co-CTFE)

The strategy of graft copolymerization from P(VDF-co-CTFE) shown in Scheme 2 can be applied to other monomers, such as acrylates. In this work, tert-butyl acrylate (tBA) was chosen as the co-monomer to grow poly(tert-butyl acrylate) (PtBA) grafts from P(VDF-co-CTFE), aiming to prepare amphiphilic graft copolymers via the hydrolysis of PtBA side chains.

TABLE 3
Graft coolymerization of tert-butyl acrylate (tBA) from P(VDF-co-CTFE)

| | | Catalyst/ | [Cl]/[CuCl]/ | | | | | | | |
|---|---|---|---|---|---|---|---|---|---|---|
| Run | | Deactivator/ | [CuCl₂]/ | Solvent | Temp. | Time | Conv. | Mₙ | | W_{PtBA} |
| No. | Initiator | Ligand | [Lig]/[tBA]^{a} | (V_{S}/V_{M})^{b} | (° C.) | (h) | (%) | (×10⁵)^{c} | PDI^{c} | (%)^{d} |
| Run 1 | 31508 | CuCl/—/ | 1/0.8/0/ | NMP | 100 | — | Gel | — | — | — |
| | | PMDETA | 0.8/40 | (2.1/1) | | | | | | |
| Run 2 | 31508 | CuCl/CuCl₂/ | 1/0.8/0.16/ | NMP | 90 | 0.75 | 31.6 | 5.73 | 1.52 | 70.9 |
| | | PMDETA | 0.8/40 | (2.1/1) | | | | | | (72.3) |
| Run 3 | 31508 | CuCl/CuCl₂/ | 1/0.4/0.08/ | NMP | 70 | 20 | 20.6 | 2.75 | 1.73 | 52.6 |
| | | PMDETA | 0.4/40 | (1.1/1) | | | | | | (63.0) |
| Run 4 | 31508 | CuCl/—/ | 1/0.8/0/ | NMP | 70 | 1 | 17.3 | 2.51 | 1.77 | 47.8 |
| | | PMDETA | 0.8/41 | (1.1/1) | | | | | | (59.3) |
| Run 5 | 31508 | CuCl/—/ | 1/0.8/0/ | NMP | 60 | 3 | 25.7 | 2.64 | 2.45 | 59.8 |
| | | PMDETA | 0.8/40 | (1.6/1) | | | | | | (68.0) |

^{a}[Cl]/[CuCI]/[Lig]/[St] is the initial molar ratio of chlorine, CuCI, ligand, and styrene;
^{b}V_{S}/V_{M} is the volume ratio between solvent and monomer (styrene);
^{c}obtained from SEC in DMF using polystyrenes as calibration standards;
^{d}weight percentage of PtBA in the resultant graft copolymers determined by elemental analysis (The data in the parentheses represent the calculated values based on the monomer conversion).

Graft copolymerizations of tBA from P(VDF-co-CTFE) were carried out under different reaction conditions. At high polymerization temperatures (such as 100° C.), cross-linking (i.e., gelation) occurred within half an hour when CuCI/PMDETA was used as the catalyst system (Run 1, Table 3). Lowering the radical concentration by decreasing the reaction temperature to 90° C. and adding a radical deactivator (CuCl₂), cross-linking was suppressed and a graft copolymer with relatively narrow molecular weight distribution was obtained (Run 2, Table 3). The graft copolymerization proceeded very rapidly at 90° C. After 45 min the reaction mixture became very viscous and the polymerization was stopped to avoid cross-linking. Further lowering of the reaction temperature to 70° C. in the presence of CuCl₂ led to a much slower copolymerization (Run 3, Table 3), and the resultant graft copolymer had a relatively narrow and monomodal molecular weight distribution. With increasing monomer conversion, the solubility of the graft copolymer in deuterated chloroform increased gradually. For example, in Run 3 in Table 3, the kinetic sample at the reaction time of 20 h (conversion=20.6%) was completely soluble in CDCl₃. This clearly indicates the successful graft copolymerization and the improvement of solubility upon grafting.

At relatively low reaction temperature (60-70° C.), the graft copolymerization could be carried out in a living manner without the addition of CuCl₂ (Runs 4-5, Table 3). FIG. 7 shows the SEC traces of a typical graft copolymer synthesized at 70° C. and the corresponding macroinitiator, P(VDF-co-CTFE)-31508. Similar to the grafting copolymerization of styrene, a positive peak was observed that shifted significantly to higher molecular weight relative to the parent fluoropolymer, indicating the successful grafting of PtBA side chains. Clearly, the molecular weight distribution for P(VDF-co-CTFE)-g-PtBA was monomodal, indicating the absence of coupling reactions.

The ¹H-NMR spectrum of the resultant polymer provides further evidence for the graft copolymerization. After the formation of the graft copolymer with PtBA side chains, a characteristic strong peak at 1.5 ppm corresponding to methyl protons in tert-butyl group appeared, as shown in FIG. 8b.

DSC was also used to investigate the thermal properties and phase separation of the graft copolymers with PtBA side chains. FIG. 9 shows the DSC thermograms of P(VDF-co-CTFE)-31508 and the corresponding graft copolymer with PtBA side chains. Very similar to P(VDF-co-CTFE)-31008, the DSC thermogram of P(VDF-co-CTFE)-31508 shows a main melting peak at 168° C. with a shoulder near 158° C. After the grafting of PtBA side chains, a new transition temperature at 117° C. was observed, corresponding to the glass transition of PtBA grafts. The position of the melting peak of the resultant graft copolymer was almost the same as that of the main melting peak of the macroinitiator, again supporting the pseudo-block structure of the macroinitiator and the selective grafting from the CTFE-rich block. The existence of both the T_{g} of the PtBA grafts and the Tm of the backbone indicates a microphase-separated morphology in this graft copolymer.

Preparation of Amphiphilic Graft Copolymer Based on P(VDF-co-CTFE)

It is well-known that PtBA can be easily converted to poly(acrylic acid) (PAA) via hydrolysis. So amphiphilic graft copolymers with PAA side chains, P(VDF-co-CTFE)-g-PAA, can be synthesized from the precursor graft copolymers, P(VDF-co-CTFE)-g-PtBA. Acidic hydrolysis of PtBA grafts was carried out in NMP at 100° C. for 2 days. ¹H-NMR measurements showed that complete hydrolysis was achieved, as indicated by the disappearance of methyl protons in tert-butyl group at 1.5 ppm (FIG. 10b).

Amphiphilic graft copolymers with hydrophobic fluorinated backbone and hydrophilic grafts have many important applications. A good example is that graft copolymers with PVDF backbone and poly(methacrylic acid) (PMAA) grafts have been used to prepare membranes with pH-sensitive separation characteristics. One can expect similar applications for the graft copolymers with P(VDF-co-CTFE) backbone and PAA side chains. Different from PVDF-g-PMAA used Ref. 16, which has very low grafting density, dense grafting can be achieved when P(VDF-co-CTFE) is used as macroinitiator. This may increases the permeability of fabricated membranes to aqueous solutions considerably.

### EXAMPLES OF THE INVENTION

The following non-limiting examples and data illustrate various aspects and features relating to the compositions and/or methods of the present invention, including the synthesis of graft fluoropolymers and related copolymers, as are available through the synthetic methodologies described herein. In comparison with prior art, present methods and/or compounds provide results and data which are surprising, unexpected and contrary thereto. While the utility of this invention is illustrated through the use of several fluoropolymers, copolymers and vinyl compounds which can be used therewith, it will be understood by those skilled in the art that comparable results are obtainable with various other fluoropolymers, copolymers and vinyl compounds, as are commensurate with the scope of this invention.

Materials

PCTFE oligomer (liquid, molecular weight=500-600 g/mol) was purchased from Polysciences Inc and used without further purification. P(VDF-co-CTFE)-31008 and P(VDF-co-CTFE)-31508, which contain 3.65 w % and 5.68 w % of chlorine respectively, were provided by Solvay Solexis. These two copolymers have a pseudo-block structure with one VDF-rich block and one CTFE-rich block. The characterization results of the PCTFE oligomer and two P(VDF-co-CTFE)s are shown in Table 4.

TABLE 4
Characterization results of the PCTFE oligomer and P(VDF-co-CTFE)s

| | | | Elemental analysis (w %) | | | | Content of |
|---|---|---|---|---|---|---|---|
| Code | Mₙ (g/mol)^{a} | PDI^{a} | C | H | F | Cl | CTFE (w %)^{b} |
| PCTFE oligomer | — | — | 18.02 | — | 41.8 | 38.8 | — |
| P(VDF-co-CTFE)- | 1.77 × 10⁵ | 1.52 | 35.93 | 2.82 | 59.0 | 3.65 | 11.99 |
| 31008 | | | | | | | |
| P(VDF-co-CTFE)- | 1.80 × 10⁵ | 1.47 | 35.21 | 2.77 | 56.7 | 5.68 | 18.66 |
| 31508 | | | | | | | |

^{a}Number-averaged molecular weight (Mn) and polydispersity index (PDI) from SEC measurements in DMF calibrated against polystyrene standards;
^{b}calculated according to the content of chlorine from elemental analysis.

Styrene (Aldrich, 99%) and tert-butyl acryale (Aldrich, 98%) were stirred over CaH₂ and vacuum distilled before use. CuCl (Aldrich, 99.995+%), CuCl₂ (Aldrich, 99.999%), 2,2′-bipyridine (BPy, Acros, 99+%), 1,1,4,7,7-pentamethyldiethylenetriamine (PMDETA, Aldrich, 99%), N,N-dimethylformamide (DMF, Acros, HPLC grade), and N-methyl-pyrrolidinone (NMP, Acros, HPLC grade) were used as received without further purification.

### Example 1a

Model Reactions

In the model reactions, poly(chlorotrifluoroethylene) (PCTFE) oligomer was used as ATRP initiator to polymerize styrene. In a typical experiment (Run 3, Table 1), PCTFE oligomer (116 mg, containing 1.27 mmol of chlorine), BPy (156 mg, 1 mmol), styrene (10.422 g, 100 mmol), and NMP (10 mL) were added into a 100 mL Schlenk flask. The mixture was degassed via three cycles of freeze-pump-thaw, and the reaction flask was filled with N₂. Then, CuCI (50 mg, 0.5 mmol) was added, and the reaction mixture was degassed again followed by refilling the flask with N₂. The reaction mixture was stirred until a homogeneous solution was obtained. An initial sample was taken for the monomer conversion measurement. The polymerization was started by immersing the reaction flask in an oil bath at a temperature of 120° C. During the polymerization, kinetics samples were taken from the reaction flask using N₂-purged syringes at desired time intervals. The samples were immediately diluted with deuterated chloroform (CDCl₃) followed by ¹H-NMR measurements to determine the monomer conversion. After 10 hours, the polymerization was stopped by cooling to room temperature and exposure to air. The reaction mixture was poured into 500 mL methanol and the polymer precipitated. The resultant polymer was dried in a vacuum oven at 60° C. overnight.

### Example 1b

The polystyrene synthesized in Run 3 in Table 1 was further used as macroinitiator to polymerize tert-butyl acrylate (tBA) via ATRP. In a typical block copolymerization (Run 4, Table 1), 1 g of polystyrene (containing 0.32 mmol of chlorine) was dissolved in 6.4 mL of NMP in the reaction flask, and then 4.55 g of tBA and 25.1 mg of CuCI (0.254 mmol) were added. After degassing, the reaction flask was filled with N₂. In a separate flask, 44.8 mg of PMDETA (0.259 mmol) was dissolved in 1.99 g of tBA. After degassing (and filling the flask with N₂), the PMDETA solution was transferred into the reaction flask using a N₂-purged syringe. An initial sample was taken for the monomer conversion measurement. The polymerization was started by immersing the reaction flask in an oil bath at a temperature of 70° C. After half an hour, the polymerization was stopped by cooling to room temperature and exposure to air. Different from the polystyrene macroinitiator, the resultant copolymer did not precipitate in methanol. A turbid dispersion was obtained when the reaction mixture was poured into methanol. Addition of water (with the volume ratio between methanol and water of 4/1) facilitated the precipitation of the resultant polymer.

### Example 2

Graft Copolymerization of Styrene from P(VDF-co-CTFE)

A typical graft copolymerization of styrene (Run 2, Table 2) is described in the following. 1.0 g of P(VDF-co-CTFE)-31008 (containing 1.03 mmol of CI) was dissolved in 15 mL of NMP in a 50 mL Schlenk flask, and then 4.61 g of styrene (44.33 mmol) was added into the P(VDF-co-CTFE) solution. After the addition of CuCI (86 mg, 0.87 mmol), the polymer solution was degassed through three cycles of freeze-pump-thaw, and then the flask was filled with N₂. Separately, 267 mg of 2,2′-bipyridine (BPy, 1.71 mmol) was dissolved in 5 mL of NMP in a 25 mL Schlenk flask, and the solution was degassed, followed by filling the flask with N₂. The bipyridine solution was then transferred into the reaction flask using a N₂-purged syringe. An initial sample was taken for the monomer conversion measurement. The reaction flask was then inmiersed in an oil bath at 120° C. During the polymerization, kinetics samples were taken from the flask using N2-purged syringes at desired time intervals. After 24 h, the polymerization was stopped by cooling to room temperature and exposure to air. The reaction mixture was diluted with acetone, and then passed through a column filled with silica gel, followed by precipitation in methanol. The resultant graft copolymer was dried in a vacuum oven at 60° C. overnight.

A control experiment (Run 3, Table 2) using PVDF homopolymer (Polysciences be, molecular weight=100 kg/mol) as macroinitiator was carried out in exactly the same manner as that described above (Run 2, Table 3), except that 1.0 g of PVDF was used in the control experiment instead of P(VDF-co-CTFE)-31008.

### Example 3

Graft Copolymerization of Tert-butyl Acrylate from P(VDF-co-CTFE)

A typical graft copolymerization of tert-butyl acrylate (tBA) (Run 2, Table 3) is described in the following. 1.0 g of P(VDF-co-CTFE)-31508 (containing 1.6 mmol of Cl) was dissolved in 15 mL of NMP in a 50 mL Schlenk flask, and then 8.254 g of tBA (64.4 mmol) was added into the polymer solution. After the addition of CuCl (128 mg, 1.29 mmol) and CuCl₂ (35 mg, 0.26 mmol), the polymer solution was degassed through three cycles of freeze-pump-thaw, and then the flask was filled with N₂. Separately, 236 mg of PMDETA (1.36 mmol) was dissolved in 5 mL of NMP in a 25 mL Schlenk flask, and the solution was degassed, followed by filling the flask with N₂. The PMDETA solution was then transferred into the reaction flask using a N₂-purged syringe. An initial sample was taken for the monomer conversion measurement. The reaction flask was then immersed in an oil bath at 90° C. During the polymerization, kinetics samples were taken from the flask using N₂-purged syringes at desired time intervals. After 45 min, the reaction mixture became very viscous. So the polymerization was stopped by cooling to room temperature and exposure to air. The reaction mixture was diluted with acetone, and then passed through a column filled with silica gel, followed by precipitation in methanol. The resulted graft copolymer was dried in vacuum oven at 60° C. overnight.

### Example 4

Hydrolysis of P(VDF-co-CTFE)-g-PtBA

0.34 g of P(VDF-co-CTFE)-g-PtBA (Run 2, Table 3) were dissolved in 25 mL of NMP, and then 1.6 mL of concentrated HCl solution (36.9%) was added. After stirring at 100° C. for 48 hours, most solvent was removed via vacuum distillation. The residual solution was poured into a mixture of methanol and water (v/v=2/1). ¹H-NMR measurements showed the complete hydrolysis of PtBA side chains.

### Example 5

Characterizations

Size exclusion chromatography (SEC) was used to determine the molecular weights and molecular weight distributions of the polymers. SEC measurements of the polymers synthesized from the model reactions were carried out in tetrahydrofuran (THF) at a flow rate of 1.0 mL/min, using three PLgel 5 μm Mixed-D columns, a Knauer K-501 HPLC pump, and a Knauer K-2301 RI detector. Linear polystyrenes were used as calibration standards. SEC measurements of P(VDF-co-CTFE)s and the graft copolymers were conducted in DMF containing 0.01 M lithium chloride at a flow rate of 1.0 mL/min at 50° C., using PL-GPC 50 system with two PL ResiPore columns. Linear polystyrene standards were used to calibrate the column set.

¹H- and ¹³C-NMR measurements were performed on a Bruker DPX 300 spectrometer. For the measurement of monomer conversion, kinetics sample (35-40 μL) was diluted with 0.6 mL of CDCl₃ and then was subjected to ¹H-NMR measurement. The monomer conversion was calculated based on the area ratio between the peak of the protons from the double bond of monomer and the peak of the methylene protons adjacent to the nitrogen atom in N-methylpyrrolidinone (solvent for polymerization).

C and H elemental analysis was performed on a 1-3 mg sample (precisely weighed to ±1 μg) through combustion at 1000° C. over a Pt combustion aide. The resultant CO₂ and H₂O were analyzed by selective thermal conductance detectors after calibration and blanking in a He stream. For the fluorine analysis, an Schoniger Oxygen Flask decomposition of a fluorine-containing sample was followed by a fluoride ion selective electrode determination of the captured gaseous products after adjusting the pH and ionic strength of the solution using standards and blanks. Chlorine was determined after an Schoniger flask decomposition of the compound. The chloride ion formed was determined using a chloridometer that titrates the chloride ion coulometrically with silver.

Differential scanning calorimetry (DSC) was performed using a Thermal Analysis Q1000 calorimeter. To avoid the influence of the thermal history, polymers were heated from 25° C. to 250° C. at 10° C./min, and then cooled to −90° C. at 10° C./min. DSC thermograms were obtained during the second heating from −90° C. to 250° C. at 10° C./min.

The morphology of P(VDF-co-CTFE) and P(VDF-co-CTFE)-g-PS was characterized using a Dimension IlIa atomic force microscope (AFM) from Digital Instruments/Veeco operated in tapping mode, using a silicon cantilever. As for the sample preparation, the polymers were dissolved in DMF with the concentration of 2 w % and the polymer solutions were spin coated onto silicon wafer at 2000 rpm for 3 min under N₂. The samples were then annealed at 190° C. under vacuum for 20 hours.

The mass spectrum of a PCTFE oligomer was acquired in FAB ionization mode on a JMS-700 MStation double focusing mass spectrometer (JEOL Inc, Peabody Mass.). ˜1 mg of sample was suspended in 3-nitrobenzyl alcohol and ionization was achieved by Xe atoms accelerated to 30 keV.

The mass spectrum is shown in FIG. 11. It is clear that the PCTFE oligomer, which was used as the initiator in the model reactions, is a mixture of PCTFE chains with different chain lengths. It contains some species with molecular weight higher than 1000, although the content of these high molecular weight species may be quite low. Because each CTFE unit carries one initiating site, the molecular weight distribution (MWD) of the PCTFE oligomer can have a dramatic influence on the MWD of the resultant polymers.

¹³C-NMR measurement on a PCTFE oligomer was performed on a Bruker DPX 300 spectrometer without ¹⁹F decoupling. CDCl₃ was used as solvent. The ¹³C-NMR spectrum is shown in FIG. 12. Due to the strong coupling between ¹³C and ¹⁹F, each ¹³C peak was split into multi peaks. The peak locations agree fairly well with those reported in literature, but it is difficult to interpret all the peaks in Figure B because of the influence of end groups and the possibility of different bonding arrangements (head-to-tail and head-to-head). From the elemental analysis, the chlorine content in the PCTFE oligomer is 38.8 w %, which is considerably higher than that in the CTFE unit (30.44 w %), suggesting that the end groups of the PCTFE oligomer most probably contain chlorine.

As demonstrated above, the secondary chlorines in CTFE units of fluoropolymers were found to be able to initiate ATRP of various monomers. A convenient method, based on the graft copolymerization of co-monomers from fluoropolymers containing CTFE units via ATRP, has been developed and used to modify some important commercial fluoropolymers, such as P(VDF-co-CTFE). Various polymers (PS, PtBA) have been grafted from P(VDF-co-CTFE), resulting in graft copolymers with improved solubility and phase compatibility. Hydrolysis of PtBA grafts of P(VDF-co-CTFE)-g-PtBA resulted in amphiphilic graft copolymers with PAA side chains, which may find potential applications in the fabrication of pH-sensitive membranes. Due to the selective grafting from the secondary chlorine in CTFE unit, the grafting density as well as the distribution of grafts solely depends on the density and distribution of CTFE units in the parent fluoropolymers.

Various fluoro-copolymers containing CTFE units are commercially available and have been widely used in the manufacture of many products due to their high mechanical strength and excellent thermal and chemical stability. These fluoropolymers have very different structures, such as alternating (copolymers of chlorotrifluoroethylene with alkyl vinyl ether), pseudo-block (P(VDF-co-CTFE)), gradient, and so forth. Based on these and other available fluoropolymers, a wide range of graft copolymers with desired structures and favorable properties can be prepared quickly and in good yield.

We claim:

1. A method of graft polymerization, comprising:
providing a fluoropolymer compound comprising at least one chlorotrifluoroethylene unit;
providing at least one vinyl compound; and
contacting the fluoropolymer and vinyl compounds under reaction conditions comprising the presence of an atom transfer radical polymerization catalyst.

2. The method of claim 1, wherein said catalyst comprises a copper(I) salt.

3. The method of claim 2, wherein said catalyst is selected from bipyridine ligand components and multi-dentate amine ligand components.

4. The method of claim 3, wherein said bipyridine ligand components are selected from 2,2′-bipyridine and 2,2′-bipyridines substituted with at least one alkyl substituent at the 4,4′-positions thereof; and said multi-dentate amine ligand components are selected from ethylenediamine, diethylenetriamine, and triethylenetetramine and said amine ligand components comprising at least one N-substituent, each said substituent independently selected from alkyl, cycloalkyl and aryl substituents.

5. The method of claim 1, wherein said fluoropolymer compound is a copolymer of chlorotrifluoroethylene with at least one monomer selected from vinyl fluoride, vinylidene fluoride, trifluoroethylene, tetrafluoroethylene, hexafluoropropylene, alkyl vinyl ether, alkyl vinyl ester, ethylene, propylene, and combinations thereof.

6. The method of claim 1, wherein said vinyl compound is selected from styrene, derivatives of styrene, acrylic acid esters, methacrylic acid esters, acrylonitrile, acrylamides, methacrylamides and combinations thereof.

7. The method of claim 6, wherein said vinyl compound is poly(ethylene oxide) methacrylate.

8. A graft copolymer compound comprising side chain grafted from chlorotrifluoroethylene monomer unit comprising a graft thereon, said unit of a formula 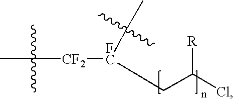
wherein R is a moiety of a grafted vinyl compound of a formula RCHCH₂, and selected from aryl, substituted aryl, alkylaryl, alkylcarbonyl, alkoxycarbonyl, amide, nitrile and poly(alkylene oxide) moieties; and n is an integer selected from 1 and integers greater than 1.

9. The copolymer compound of claim 8 comprising a monomer selected from styrene, derivatives of styrene, acrylic acid esters, methacrylic acid esters, acrylonitrile, acrylamides, methacrylamides and combinations thereof.

10. The copolymer compound of claim 8 wherein R is selected from one of said carbonyl moieties, said compound hydrolyzed to provide a poly(acrylic acid) graft.

11. The copolymer compound of claim 8, wherein R is a poly(ethylene oxide) moiety.

12. The copolymer compound of claim 8 contacted with a fluoropolymer and a polymer of said grafted vinyl compound, said copolymer compound a compatilizer between said fluoropolymer and said polymer.

13. The copolymer of claim 8 coupled to a substrate.

14. The copolymer of claim 13 wherein R is a poly(alkylene oxide) moiety.

15. A method of using a chlorotrifuoroethylene unit for initiating atom transfer radical polymerization, said method comprising:
providing a reaction medium comprising a vinyl compound and a fluoropolymer compound comprising at least one chlorotrifluoroethylene unit; and
contacting said medium with an atom transfer radical polymerization catalyst for a time at least partially sufficient for polymerization of said vinyl compound initiated from said chlorotrifluoroethylene unit.

16. The method of claim 15, wherein said fluoropolymer compound is a copolymer of chlorotrifluoroethylene with at least one monomer selected from vinyl fluoride, vinylidene fluoride, trifluoroethylene, tetrafluoroethylene, hexafluoropropylene, alkyl vinyl ether, alkyl vinyl ester, ethylene, propylene, and combinations thereof.

17. The method of claim 15, wherein said fluoropolymer is selected from a random copolymer comprising chlorotrifluoroethylene, an alternating copolymer comprising chlorotrifluoroethylene, and a block copolymer comprising chlorotrifluoroethylene.

18. A system for atom transfer radical polymerization, said system comprising a fluoropolymer comprising at least one chlorotrifluoroethylene monomer unit, a vinyl compound, a catalyst complex comprising a copper(I) salt and a nitrogenous ligand component, and a reaction medium.

19. The system of claim 18, wherein said copper(I) salt is a copper(I) halide.

20. The system of claim 18, wherein said nitrogenous ligand component is selected from 2,2′-bipyridine, and 2,2′-bipyridines substituted with at least one alkyl substituent at the 4,4′-positions thereof, ethylenediamine, diethylenetriamine, triethylenetetramine and said amines comprising at least one N-substituent, each said substituent independently selected from alkyl, cycloalkyl and aryl substituents.

21. The system of claim 18, wherein said vinyl compound is selected from styrene, derivatives of styrene, acrylic acid esters, methacrylic acid esters, acrylonitrile, acrylamides, methacrylamides, poly(ethylene oxide) methacrylate and combinations thereof.

22. The system of claim 18 wherein a graft polymerization product obtainable therefrom is contacted with a substrate.

23. A polymer compound of a formula 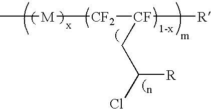
wherein M is selected from an ethylene unit and an ethylene unit comprising a moiety selected from chloro, fluoro, alkyl, substituted alkyl, alkoxy, alkoxycarbonyl and combinations thereof, R is selected from aryl, substituted aryl, alkylaryl, substituted alkylaryl, alkylcarbonyl, alkoxycarbonyl, carboxy, amide, nitrile, and poly(alkylene oxide) moieties; m is an integer selected from 1 and integers greater than 1; n is an integer selected from 1 and integers greater than 1; x is greater than 0 and smaller than 1; and R′ is a polymerization termination moiety.

24. The compound of claim 23 wherein M is selected from vinyl fluoride, vinylidene fluoride, trifluoroethylene, tetrafluoroethylene, hexafluoropropylene, alkyl vinyl ether, alkyl vinyl ester, ethylene, propylene, and combinations thereof.

25. The compound of claim 24 wherein R is selected from aryl, substituted aryl, alkylaryl, alkylcarbonyl, alkoxycarbonyl, carboxy, amide, nitrile, and poly(alkylene oxide) moieties.

26. The polymer compound of claims 23 selected from random, alternating, and block copolymers.

27. The polymer compound of claim 23 obtainable from a graft polymerization method of claim 1, said atom transfer radical polymerization catalyst comprising a copper(I) salt and a nitrogenous ligand.
